(19) United States
(12) Patent Application Publication
(10) Pub. No.: US 2005/0235036 A1
(43) Pub. Date: Oct. 20, 2005

(54) Intelligent URL redirector

(76) Inventors: Jim R. Nielsen, Grand Blanc, MI (US); Mike Alexander, Waterford, MI (US)

Correspondence Address: STEPHEN R. LOE, THE LAW OFFICE OF STEPHEN R. LOE, P.O. BOX 649, FRISCO, TX, 75034, US

(21) Appl. No.: 10/827,056

(22) Filed: Apr. 19, 2004

(51) Int. Cl. G06F 15/16; G06F 15/173

(52) U.S. Cl. 709/206; 709/238

(57) ABSTRACT

A method, system, and computer program product for directing a recipient of an e-mail to a web site is provided. In one embodiment, an e-mail with an embedded link is created, wherein the embedded link comprises a link to a redirect server and link attributes that allow the redirect server to determine a current web site associated with the embedded link. The e-mail with the embedded link is then sent to a recipient. The e-mail is received by the recipient and, responsive to the recipient selecting the embedded link within the e-mail, link attributes are sent from the recipient's data processing system to the redirect server. The link attributes are received at the redirect server and the redirect server determines the universal resource locator for the current web site associated with the embedded link. The universal resource locator is then sent from the redirect server to the recipient, which then utilizes the universal resource locator to retrieve the contents from the current web site.

### BACKGROUND OF THE INVENTION

1. Technical Field

The present invention relates generally to computer software and, more particularly, to electronic mail and embedded universal resource locator links.

2. Description of Related Art

E-mail has become ubiquitous in today's world and, as such, and because of its convenience to the consumer as well as the business, many businesses have come to utilize e-mail as part of their marketing process. Because many e-mail programs support formatted information rather than just text, many businesses have utilized the multimedia features supported by e-mail programs to dress up their e-mail advertisements. For example, it is common now for e-mail advertisements to be formatted in, for example, Hypertext Markup Language (HTML), and contain pictures, other graphics, and/or animation with Universal Resource Locator (URL) (i.e., links to web pages) imbedded in the images or as separate text. This allows the e-mail recipient to conveniently navigate to the web site of the business containing more information about the product advertised and/or a web page for purchasing the advertised item.

Typically, these e-mails are built using templates placing images in locations in the template, such as, for example, the logo of the business, top navigation, and an image of the product advertised. Each of these images may contain a link to a destination at a business web site. For example, an advertisement for an automobile may contain an image of the advertised automobile, which contains a link to a web page providing more information about the advertised automobile, as well as a logo for the automobile manufacturer with the logo providing a link to the manufacturer's general web site. In any case, the URL is hard-coded into the e-mail sent to the consumer.

However, consumers often times do not immediately click on the link in the e-mail when they receive the e-mail, but instead wait until a more convenient time to peruse the contents of the e-mail. However, often times it becomes necessary, for a variety of reasons, after the e-mail is sent, to change the location of the web page to which the URL embedded in the e-mail referred. Thus, for consumers who wait too long to click on the link or for consumers who wish to come back to the web page at a later time, the destination URL embedded in the image is no longer be available. This is frustrating for the consumer and may lead to a lost sale or, at the very least, some ill will toward the business.

Therefore, it would be desirable to have a method, system, and computer program product that allows a business to send an e-mail with an embedded link that allows the business to change the location of the web page while still allowing the consumer to access to the web page through the embedded link in the e-mail message.

### SUMMARY OF THE INVENTION

The present invention provides method, system, and computer program product for directing a recipient of an e-mail to a web site. In one embodiment, an e-mail with an embedded link is created, wherein the embedded link comprises a link to a redirect server and link attributes that allow the redirect server to determine a current web site associated with the embedded link. The e-mail with the embedded link is then sent to a recipient. The e-mail is received by the recipient and, responsive to the recipient selecting the embedded link within the e-mail, link attributes are sent from the recipient's data processing system to the redirect server. The link attributes are received at the redirect server and the redirect server determines the universal resource locator for the current web site associated with the embedded link. The universal resource locator is then sent from the redirect server to the recipient, which then utilizes the universal resource locator to retrieve the contents from the current web site.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server is depicted in accordance with the present invention;

FIG. 3 depicts a block diagram of a data processing system in which the present invention may be implemented;

FIG. 4 depicts a pictorial diagram illustrating a system of sending electronic mail (e-mail) with embedded links to web sites and system for providing the web sites to a user in accordance with one embodiment of the present invention;

FIG. 5 depicts a diagram illustrating an exemplary process flow and program function for creating and sending an e-mail with embedded links in accordance with one embodiment of the present invention;

FIG. 6 depicts a diagram illustrating an exemplary process flow and program function for receiving an e-mail with an embedded link and retrieving web site associated with the content of the e-mail in accordance with one embodiment of the present invention; and

FIG. 7 depicts a diagram illustrating an exemplary process flow and program function for redirecting a user to an appropriate web site in accordance with one embodiment of the present invention.

### DETAILED DESCRIPTION OF THE PREFERRED EMBODIMENT

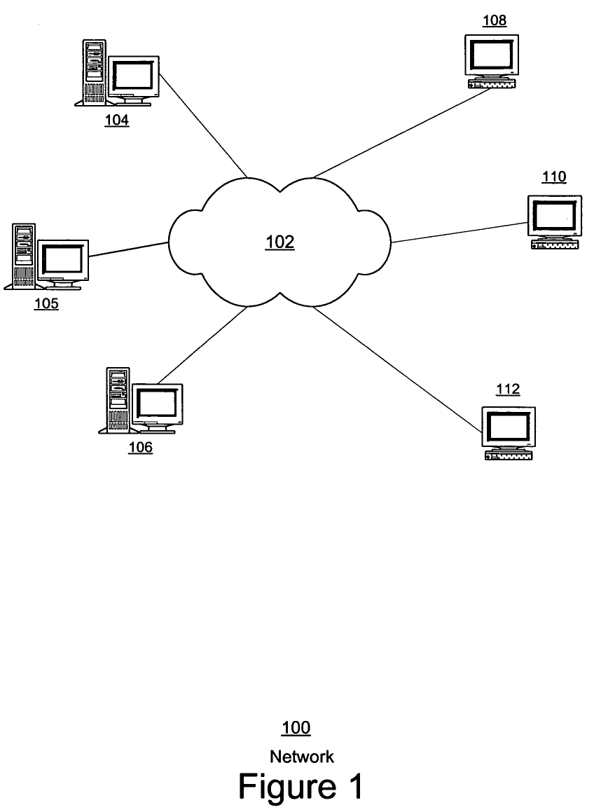

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, e-mail server 104, redirector server 105, and web server 106 are connected to network 102. In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. Distributed data processing system 100 may include additional servers, clients, and other devices not shown.

In the depicted example, e-mail server 104 e-mail messages to clients 108-112. Some of the e-mail messages may include text, graphics, and Universal Resource Locators (URLs), commonly referred to as “links”, embedded in the text and/or graphics. The links contain a link to a redirect server 105 and a set of parameters that identify the content the sender of the e-mail desires for the e-mail recipient to access. When a user “clicks” or otherwise selects the embedded link, the user's client, such as any one of client's 108-112 accesses the redirect server 105 and provides the redirect server 105 with the set of parameters that were embedded in the link. The redirect server determines the location of correct and current the web site that the e-mail sender desires the e-mail recipient to access and sends the address of this web site back to the client 108-112. The client 108-112 then accesses the web site on, for example, web server 106 and retrieves the content from the web site to provide to the user.

The embedded link in the e-mail message does not contain a hard coded link to the web site since it is possible that the content that the e-mail sender desires the recipient may change or be relocated to a different web site. Thus, by sending a link to the redirect server rather than to a web site, the e-mail sender may change the content and location of the web site at will and merely update a database on the redirect server 105 and still have the e-mail recipient directed to the correct web site even if the recipient does not “click” on the embedded link for some time after the e-mail sender sent the e-mail to the recipient.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network.

FIG. 1 is intended as an example and not as an architectural limitation for the processes of the present invention.

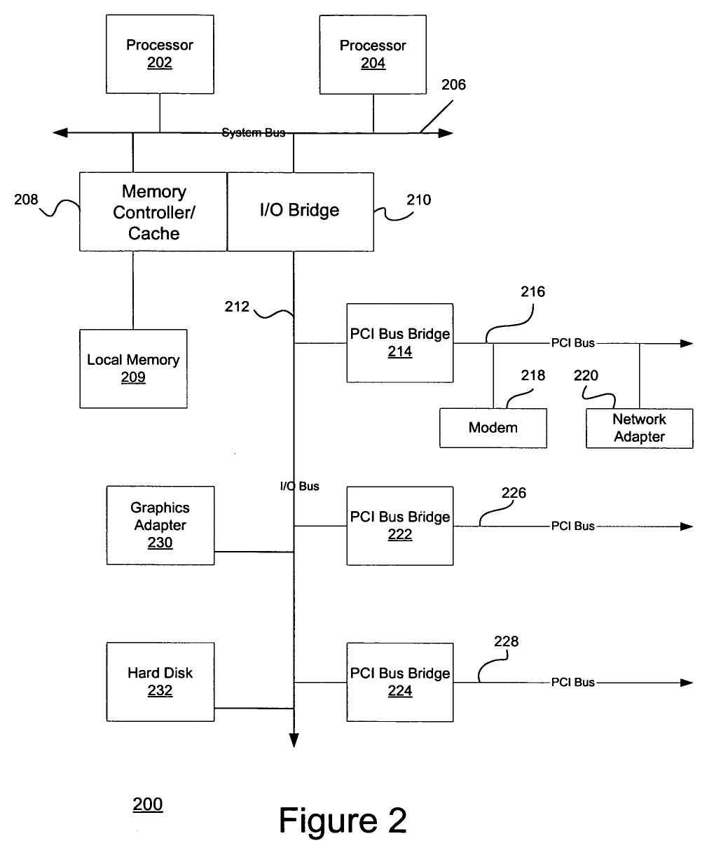

Referring to FIG. 2, a block diagram of a data processing system which may be implemented as a server, such as any one of servers 104-106 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

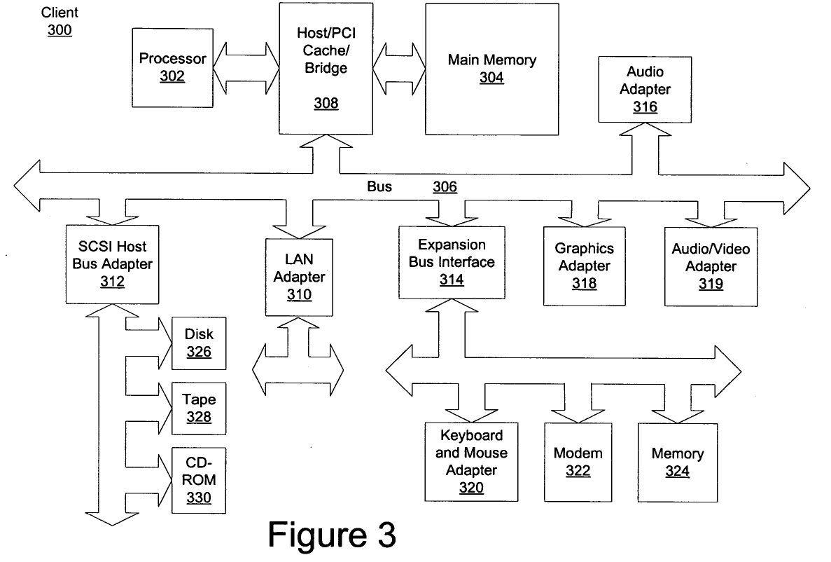

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

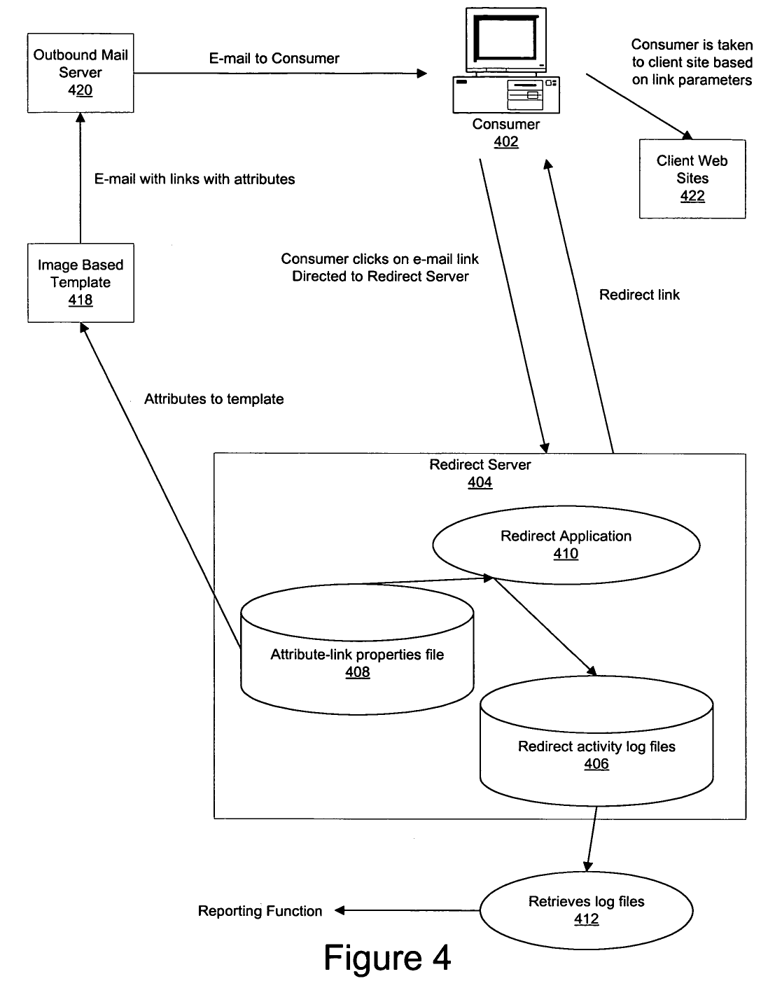

With reference now to FIG. 4, a pictorial diagram illustrating a system of sending electronic mail (e-mail) with embedded links to web sites and system for providing the web sites to a user is depicted in accordance with one embodiment of the present invention. One embodiment of a redirect server system depicted in FIG. 4 comprises a redirect server 404, an image based template 418, an outbound mail server 420, a consumer data processing system 402, and client web sites 422. The redirect server 404 includes an attribute-link properties file 408, a redirect application 410, and redirect activity log files 406. Redirect server 404 and Outbound mail server 420 may be implemented as, for example, server 200 depicted in FIG. 2. Consumer 402 may be implemented as, for example, data processing system 300 depicted in FIG. 3.

E-mails, such as, for example, marketing e-mails, are sent to consumers 402 from outbound mail server 420. The e-mails are typically built using a template by placing images, such as, for example, the logo, top navigation, product image placeholder, etc., in location in the template. Some images or text in these e-mails contain links to web sites that the sender of the e-mail would like the consumer 402 to visit. However, rather than hard-code the destination universal resource locator (URL) into the e-mail sent to consumers 402 as in the prior art, the redirect system of the present invention separates the actual destination (URL) from the e-mail link and replaces it with a link to redirect server 404 which maintains an attribute-link properties file 408 allowing redirect application 410 to determine the current location of the client web site(s) 422 that the sender of the e-mail desires the consumer 402 to visit. The redirect application 410 will then forward to the consumer 402 the URL of the web site 422 that e-mail sender desires the consumer 402 to visit.

Thus, a group, such as, for example, an eMarketing mail support group, works with various agencies within an organization in charge of different web sites to coordinate link destinations desired for each e-mail and maintains these link properties in an attribute-link properties file 408. Links are inserted into various locations in image based template 418 as desired where the links direct a consumer 402 to various web sites 422 depending upon which link is selected by the consumer 402. However, the links do not contain a URL for the desired client web sites 422 but contain a URL directing the consumer 402 to the redirect server 404 and link attributes that are readable by redirect application 410. The link attributes allow redirect application 410 to consult attribute-link properties file 408 to determine a current location for the desired web site 422 based on the link attributes.

Once the image based template 418 has been encoded with the link attributes and URL to the redirect sever 404 and with any other information desired to be sent to the consumer 402, the e-mail with link attributes is sent to outbound mail server 420 which then sends the e-mail to each consumer 402 specified by the organization.

Once the consumer 402 receives the e-mail, the consumer 402 may select one of the links within the e-mail in order to retrieve more information about a subject from the client web site 422. However, by selecting the link, the consumer 402 is not immediately directed to client web sites 422, but rather is directed to redirect server 404. The consumer 402 sends the redirect server link attributes associated with the link selected by consumer 402. A redirect application 410 within redirect server 404 consults attribute-link properties file 408 to determine the current location of the web site 422 associated with the link selected by the consumer 402. Redirect application 410 then returns a redirect link with the current URL for the desired web site 422 to consumer 402 which then uses the current URL to access client web site 422.

The eMarketing mail support group maintains the attribute-link properties file 408 updating the file so that the current location of client web sites 422 are associated with the appropriate link properties within attribute-link properties file 408. Thus, if for some reason it becomes desirable or necessary to change the URL location for the web site 422 associated with the links sent to a user in an e-mail, the user may nevertheless be able to navigate to the appropriate web site 422 since the e-mail that the consumer 402 received contains not a URL for the web site, but a URL for the redirect server 404 with link properties allowing the redirect server to determine and send the consumer 402 the correct current URL for the web site associated with the selection made by the consumer 402.

The redirect application 410 also records redirect activity to log files 406 which may be read by a retrieve log files function 412 and sent to a reporting function to allow various persons to monitor the activity and function of the redirect system.

In some embodiments, the link associations (i.e., the associations between the current URLs and the link attributes) may be kept in a spreadsheet, such as, for example, an Excel® spreadsheet. Excel® is a product and registered trademark of the Microsoft Corporation of Redmond, Wash. In other embodiments, rather than utilizing a spreadsheet, the association of parameters or link attributes to link destinations could be maintained in a database.

In one embodiment, the redirect application 410 is based on a Java servlet architecture built with open source Struts framework. The servlet processes incoming request, then processes the parameters on the request to format a key. This key is used to find a URL destination within the organization's family of web sites where the agencies desire the e-mail recipient to go when the recipient clicks on an image in the e-mail. The key/url destination(value) pair are loaded into the servlet at startup time. The key/value pairs are in a ‘.properties’ file. This file is built from a template used by, for example, an advertising agency, to manage what link should be associated with an image in the e-mail.

Some benefits of the present invention are that additional e-mail campaigns using embedded links in rich content e-mails can be implemented with minimal effort. New link and segment additions do not require rework of existing e-mail content. Addition of a new segment will change the Links Application instead of change to all e-mail versions, saving effort and cost. The present invention also provides immediate change to all versions of outbound mailers. When a link is changed all future and previously sent e-mails are effectively updated. This means all users are being directed to the most current content. The present invention provides extremely quick turnaround on delivering new high priority incentives, changes, content, etc. to market. The present invention can be used in other outbound campaigns as well as a redirect management tool for static web pages. Parameterized default destination URLs have been added by the present invention to the processing to help avoid users receiving ‘page no found (404)’ errors.

If the present invention is provided by a IT firm to clients to aid clients in reaching target consumers, the solution can also be extended such that the IT firm can provide the service to multiple clients and not just a single client. The activity logs could be incorporated into a reporting and analysis process to help understand user activity with information such as which links were chosen the most, what is a typical latency time from the e-mail being sent to being acted on with a link, the relationship of: how the consumers' information requests to getting the e-mail to clicking on the e-mail to taking action at the client site.

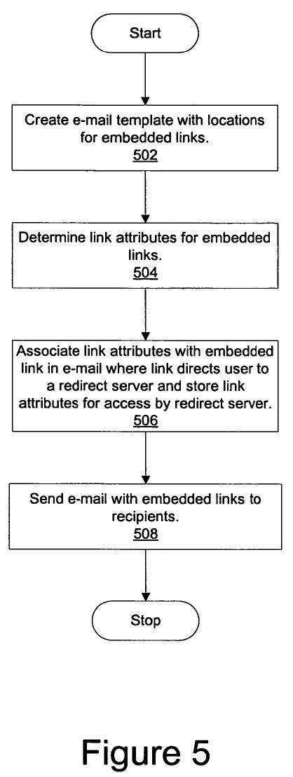

With reference now to FIG. 5, a diagram illustrating an exemplary process flow and program function for creating and sending an e-mail with embedded links is depicted in accordance with one embodiment of the present invention. To begin, an e-mail template with locations for embedded links is created (step 502). Link attributes (such as, for example, the content or type of content to be linked to, the product or service name advertised in the e-mail, graphic name, etc.) for the embedded links are determined (step 504). The link attributes along with a universal resource locator (URL) directing an e-mail recipient's web browser to the redirect server are embedded in the e-mail and the link attributes and location of a web page associated with the link attributes are stored to be accessed by the redirect server (step 506). The e-mail, with embedded links and associated link attributes are sent to e-mail recipients (step 508).

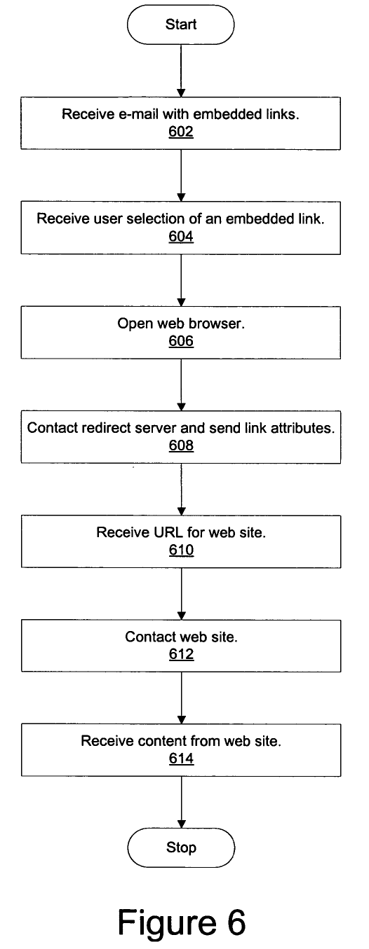

Referring now to FIG. 6, a diagram illustrating an exemplary process flow and program function for receiving an e-mail with an embedded link and retrieving web site associated with the content of the e-mail is depicted in accordance with one embodiment of the present invention. A recipient receives an e-mail with embedded links (step 602). The recipient may chose to open the e-mail and desire more information about an item descried in the e-mail. The recipient, therefore, selects (such as, for example, by situating a cursor inside an area of the video display device and then “clicking” a mouse button on the user's mouse) the link, embedded in the e-mail associated with the item for which the user desires more information. The user's e-mail software receives the user's selection of the embedded link (step 604), opens a web browser (step 606), and instructs the web browser to contact the redirect server and send link attributes associated with the particular embedded link selected by the user (step 608).

The redirect server receives the link attributes, determines the URL of the web site to direct the recipient to, and sends the URL back to the recipient. The recipient's web browser receives the URL for the web site from the redirect server (step 610) and contacts the web site using the newly acquired URL (step 612). The web browser then receives the content from the web site and displays it to the e-mail recipient (step 614).

Although described in the context of an e-mail program and separate web browser, such a configuration is not required. For example, in some embodiments, the e-mail function and web browsing function may be incorporated into a single software product. Thus, the particular implementation chosen to receive e-mail and retrieve web pages should not inferred as a limitation of the present invention.

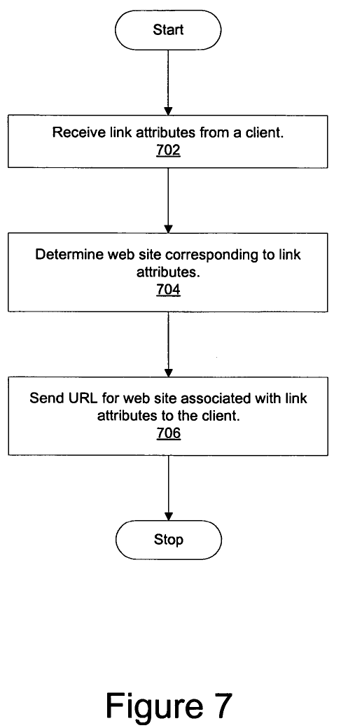

With reference now to FIG. 7, a diagram illustrating an exemplary process flow and program function for redirecting a user to an appropriate web site is depicted in accordance with one embodiment of the present invention. To begin, the redirect server receives link attributes from a client (step 702). The redirect server consults a link attribute properties file or database to determine the URL for the web site corresponding to the link attributes received from the client (step 704). Once the redirect server has determined the appropriate URL, the redirect server sends the URL for the web site associated with the link attributes to the client (step 706) which may then use it to access the web site.

Although the present invention has been descried primarily in terms of image based template e-mails used for marketing purposes, those skilled in the art will recognize that the invention is not limited to such purposes nor to such e-mail formats, but may be extended to any type of e-mail containing links and used for any purpose for which e-mails are utilized.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for directing a recipient of an e-mail to a web site, the method comprising:
creating an e-mail with an embedded link, wherein the embedded link comprises a link to a redirect server and link attributes that allow the redirect server to determine a current web site associated with the embedded link;
sending the e-mail to a recipient;
receiving the e-mail at the recipient's data processing system;
responsive to the recipient selecting the embedded link, sending link attributes from the recipient's data processing system to the redirect server;
receiving the link attributes at the redirect server;
determining, at the redirect server, the universal resource locator for the current web site associated with the embedded link;
sending the universal resource locator from the redirect server to the recipient; and
retrieving, at the recipient's data processing system, the contents from the current web site utilizing the universal resource locator received from the redirect server.

2. The method as recited in claim 1, wherein link attributes and associated universal resource locators corresponding to the link attributes are contained in a link attribute properties file which may be accessed by a redirect server to determine the universal resource locator for the web site associated with the link attributes received from the recipient.

3. The method as recited in claim 2, wherein the link attribute properties file may be updated to contain the most recent universal resource locators as necessary.

4. The method as recited in claim 2, wherein the link attributes comprise a key and the link attribute properties file contains key/universal resource locator pairs allowing the redirect server to search a key and retrieve an appropriate corresponding universal resource locator.

5. A computer program product in computer readable media for use in data processing systems for directing a recipient of an e-mail to a web site, the computer program product comprising:
first instructions for creating an e-mail with an embedded link, wherein the embedded link comprises a link to a redirect server and link attributes that allow the redirect server to determine a current web site associated with the embedded link;
second instructions for sending the e-mail to a recipient;
third instructions for receiving the e-mail at the recipient's data processing system;
fourth instructions, responsive to the recipient selecting the embedded link, for sending link attributes from the recipient's data processing system to the redirect server;
fifth instructions for receiving the link attributes at the redirect server;
sixth instructions for determining, at the redirect server, the universal resource locator for the current web site associated with the embedded link;
seventh instructions for sending the universal resource locator from the redirect server to the recipient; and
eighth instructions for retrieving, at the recipient's data processing system, the contents from the current web site utilizing the universal resource locator received from the redirect server.

6. The computer program product as recited in claim 5, wherein link attributes and associated universal resource locators corresponding to the link attributes are contained in a link attribute properties file which may be accessed by a redirect server to determine the universal resource locator for the web site associated with the link attributes received from the recipient.

7. The computer program product as recited in claim 6, wherein the link attribute properties file may be updated to contain the most recent universal resource locators as necessary.

8. The computer program product as recited in claim 6, wherein the link attributes comprise a key and the link attribute properties file contains key/universal resource locator pairs allowing the redirect server to search a key and retrieve an appropriate corresponding universal resource locator.

9. A system for directing a recipient of an e-mail to a web site, the system comprising:
first means for creating an e-mail with an embedded link, wherein the embedded link comprises a link to a redirect server and link attributes that allow the redirect server to determine a current web site associated with the embedded link;
second means for sending the e-mail to a recipient;
third means for receiving the e-mail at the recipient's data processing system;
fourth means, responsive to the recipient selecting the embedded link, for sending link attributes from the recipient's data processing system to the redirect server;
fifth means for receiving the link attributes at the redirect server;
sixth means for determining, at the redirect server, the universal resource locator for the current web site associated with the embedded link;
seventh means for sending the universal resource locator from the redirect server to the recipient; and
eighth means for retrieving, at the recipient's data processing system, the contents from the current web site utilizing the universal resource locator received from the redirect server.

10. The system as recited in claim 9, wherein link attributes and associated universal resource locators corresponding to the link attributes are contained in a link attribute properties file which may be accessed by a redirect server to determine the universal resource locator for the web site associated with the link attributes received from the recipient.

11. The system as recited in claim 10, wherein the link attribute properties file may be updated to contain the most recent universal resource locators as necessary.

12. The system as recited in claim 10, wherein the link attributes comprise a key and the link attribute properties file contains key/universal resource locator pairs allowing the redirect server to search a key and retrieve an appropriate corresponding universal resource locator.

13. A method for creating and sending an e-mail with embedded links, the method comprising:
creating an e-mail;
embedding a link to a redirect server in the e-mail to create an e-mail with an embedded link, wherein the link to the redirect server comprises link attributes enabling the redirect server to determine a current location for a web site for which it is desired that a recipient of the e-mail with an embedded link visit;
sending the e-mail with an embedded link to a recipient.

14. The method as recited in claim 13, wherein the link attributes comprises a key wherein the key corresponds to a key maintained in a properties file which associates web site locations with keys.

15. The method as recited in claim 14, wherein the web site location is a universal resource locator.

16. The method as recited in claim 14, wherein the properties file is a spreadsheet.

17. The method as recited in claim 14, wherein the properties file is a database.

18. A computer program product in a computer readable media for use in a data processing system for creating and sending an e-mail with embedded links, the computer program product comprising:
first instructions for creating an e-mail;
second instructions for embedding a link to a redirect server in the e-mail to create an e-mail with an embedded link, wherein the link to the redirect server comprises link attributes enabling the redirect server to determine a current location for a web site for which it is desired that a recipient of the e-mail with an embedded link visit;
third instructions for sending the e-mail with an embedded link to a recipient.

19. The computer program product as recited in claim 18, wherein the link attributes comprises a key wherein the key corresponds to a key maintained in a properties file which associates web site locations with keys.

20. The computer program product as recited in claim 19, wherein the web site location is a universal resource locator.

21. The computer program product as recited in claim 19, wherein the properties file is a spreadsheet.

22. The computer program product as recited in claim 19, wherein the properties file is a database.

23. A system for creating and sending an e-mail with embedded links, the system comprising:
first means for creating an e-mail;
second means for embedding a link to a redirect server in the e-mail to create an e-mail with an embedded link, wherein the link to the redirect server comprises link attributes enabling the redirect server to determine a current location for a web site for which it is desired that a recipient of the e-mail with an embedded link visit;
third means for sending the e-mail with an embedded link to a recipient.

24. The system as recited in claim 23, wherein the link attributes comprises a key wherein the key corresponds to a key maintained in a properties file which associates web site locations with keys.

25. The system as recited in claim 24, wherein the web site location is a universal resource locator.

26. The system as recited in claim 24, wherein the properties file is a spreadsheet.

27. The system as recited in claim 24, wherein the properties file is a database.

28. A method for retrieving a web site associated with a link in an e-mail, the method comprising:
receiving an e-mail with an embedded link;
responsive to selection of the embedded link by a user; sending link attributes contained in the embedded link to a redirect server indicated by the embedded link;
receiving a web site location from the redirect server; and
retrieving content from the web site location.

29. The method as recited in claim 28, wherein the link attributes comprise a key.

30. A computer program product in a computer readable media for use in a data processing system for retrieving a web site associated with a link in an e-mail, the computer program product comprising:
first instructions for receiving an e-mail with an embedded link;
second instructions, responsive to selection of the embedded link by a user; for sending link attributes contained in the embedded link to a redirect server indicated by the embedded link;
third instructions for receiving a web site location from the redirect server; and
fourth instructions for retrieving content from the web site location.

31. The computer program product as recited in claim 30, wherein the link attributes comprise a key.

32. A system for retrieving a web site associated with a link in an e-mail, the system comprising:
first means for receiving an e-mail with an embedded link;
second means, responsive to selection of the embedded link by a user; for sending link attributes contained in the embedded link to a redirect server indicated by the embedded link;
third means for receiving a web site location from the redirect server; and
fourth means for retrieving content from the web site location.

33. The system as recited in claim 32, wherein the link attributes comprise a key.

34. A method for redirecting an e-mail recipient to a current location of a web site associated with a link embedded in the e-mail, the method comprising:
receiving link attributes from a recipient;
determining a location for the web site associated with the link attributes;
sending the location for the web site associated with the link attributes to the recipient.

35. The method as recited in claim 34, wherein determining a location for the web site associated with the link attributes comprises consulting a link attribute file that contains attribute location pairs.

36. The method as recited in claim 34, wherein the link attributes comprise a key.

37. The method as recited in claim 34, wherein the web site location comprises a universal resource locator.

38. The method as recited in claim 35, wherein the link attribute file is a spreadsheet.

39. The method as recited in claim 35, wherein the link attribute file is a database.

40. A computer program product in a computer readable media for use in a data processing system for redirecting an e-mail recipient to a current location of a web site associated with a link embedded in the e-mail, the computer program product comprising:
first instructions for receiving link attributes from a recipient;
second instructions for determining a location for the web site associated with the link attributes;
third instructions for sending the location for the web site associated with the link attributes to the recipient.

41. The computer program product as recited in claim 40, wherein determining a location for the web site associated with the link attributes comprises consulting a link attribute file that contains attribute location pairs.

42. The computer program product as recited in claim 40, wherein the link attributes comprise a key.

43. The computer program product as recited in claim 40, wherein the web site location comprises a universal resource locator.

44. The computer program product as recited in claim 41, wherein the link attribute file is a spreadsheet.

45. The computer program product as recited in claim 41, wherein the link attribute file is a database.

46. A system for redirecting an e-mail recipient to a current location of a web site associated with a link embedded in the e-mail, the system comprising:
first means for receiving link attributes from a recipient;
second means for determining a location for the web site associated with the link attributes;
third means for sending the location for the web site associated with the link attributes to the recipient.

47. The system as recited in claim 46, wherein determining a location for the web site associated with the link attributes comprises consulting a link attribute file that contains attribute location pairs.

48. The system as recited in claim 46, wherein the link attributes comprise a key.

49. The system as recited in claim 46, wherein the web site location comprises a universal resource locator.

50. The system as recited in claim 47, wherein the link attribute file is a spreadsheet.

51. The system as recited in claim 47, wherein the link attribute file is a database.
